(19) United States
(12) Patent Application Publication
(10) Pub. No.: US 2007/0106993 A1
(43) Pub. Date: May 10, 2007

(54) Computer security method having operating system virtualization allowing multiple operating system instances to securely share single machine resources

(76) Inventors: Kenneth Largman, San Francisco, CA (US); Anthony B. More, Sebastopol, CA (US); Jeffrey Blair, San Francisco, CA (US); Kip Macy, Incline Village, NV (US)

Correspondence Address: PERKINS COIE LLP, P.O. BOX 2168, MENLO PARK, CA, 94026, US

(21) Appl. No.: 11/585,790

(22) Filed: Oct. 23, 2006

Related U.S. Application Data
(60) Provisional application No. 60/729,324, filed on Oct. 21, 2005.
(60) Provisional application No. 60/841,850, filed on Aug. 31, 2006.

(51) Int. Cl. G06F 9/46

(52) U.S. Cl. 718/104

(57) ABSTRACT

This invention relates generally to computer security and more particularly to operating system virtualization achieved by inserting a hypervisor layer between the operating system and the underlying hardware that is responsible for allowing multiple operating system instances and their running applications to share the resources of a single machine.

### RELATED APPLICATIONS

Applicant hereby claims the benefit of priority to U.S. Provisional Patent Application Ser. No. 60/729,324 filed 21 Oct. 2005 and entitled “Computer Security Method Having Operating System Virtualization Allowing Multiple Operating System Instances To Securely Share Single Machine Resources”; which application is hereby incorporated by reference.

This application also claims the benefit of priority to U.S. Provisional Patent Application Ser. No. 60/841,850 filed Aug. 31, 2006 and entitled “Network Computer System And Method Using Thin User Client And Virtual Machine To Provide Immunity To Hacking, Viruses, And Spy-Ware”, which application is hereby incorporated by reference.

U.S. patent application Ser. No. 10/760,131 filed 24 Jan. 2004 and published as US 20040236874 and entitled Computer System Architecture And Method Providing Operating-System Independent Virus-, Hacker-, And Cyber-Terror-Immune Processing Environments, is a related application and is hereby incorporated by reference.

### FIELD OF THE INVENTION

This invention relates generally to computer security and more particularly to operating system virtualization achieved by inserting hypervisor layer between the operating system and the underlying hardware that is responsible for allowing multiple operating system instances and their running applications to share the resources of a single machine.

### BACKGROUND

Currently, most if not all security controls in computers and computer systems rely on the secure environment of their operating system. Application programs and program suites with varying or conflicting security requirements may have to be installed and run on separate hardware or rely on their operating systems to isolate the application program sets and impose and enforce different security and/or access requirements within the sets.

This reliance on the operating system as the guardian of security brings into focus a fundamental contemporary computer and information system security problem: currently available operating systems do not solve or attempt to solve the application program isolation issue because they operate under a model where the sharing of many critical resources is required. Shared resources for example include such elements as shared libraries, file systems, network, and display memory and processors, without meaningful separation. Furthermore, discretionary access controls common in products cannot solve the generic problem of malicious code (viruses, spy-ware, hacker code, pop-ups, Trojan horses, or the like.) since they cannot readily identify or separate what a user intends to run or execute, from what a user is or may be unintentionally executing (such as viral code attached to a user file). Also, discretionary controls may unfortunately assume that users are acting in an authorized way, and this may not always be the case. Vulnerable applications, careless, or unsophisticated users may allow malicious code to enter the system or data structure and compromise a system.

These problems cannot be readily solved by adding a higher-level security infrastructure in conventional ways. Considering the most important predicted threats against system security (such as for example malicious developers, trap doors left during distribution, boot-sector viruses, root-kits, and compiler trap doors) effective security cannot be implemented in layers above the operating system (that is, for example, in applications or middleware) because related security controls can be bypassed by those threats. Various integrity checkers, anti-virus scanners, and similar security applications are useful for mitigating risk, but have not and cannot provide security guarantees as they themselves may be compromised by the malicious code they are intended to detect, in addition, for certain anti-virus and anti-spyware, they require prior knowledge of the code or code segments or code signatures they are intended to detect.

Therefore there remains a need for system, system architecture, method, and computer program software, that mitigate the threat from such malicious code and provide a measure of security guarantee that solves these shortcomings and problems.

### SUMMARY

This invention relates generally to computer security and more particularly to operating system virtualization achieved by inserting a hypervisor layer between the operating system and the underlying hardware that is responsible for allowing multiple operating system instances and their running applications to share the resources of a single machine.

### BRIEF DESCRIPTION OF THE DRAWINGS

FIG. 1 is an illustration showing an embodiment of a Copy-on-Write(COW) optimization strategy.

FIG. 2 is an illustration showing Operating System (OS) upgrades and COW.

FIG. 3 is an illustration showing application upgrades and COW.

FIG. 4 is an illustration showing “hooking” and re-routing commands to a management system control environment.

FIG. 5 is an illustration showing creation of a virtual machine and open dialog.

FIG. 6 is an illustration showing routing and transfer of file information to a vir2us™ control environment (reference monitor) and then back to application.

FIG. 7 is an illustration showing verification of file access rights by reference monitor.

### DETAILED DESCRIPTION

The above problems and limitations of the conventional systems and methods are solved by the inventive approach in which Operating System (OS) virtualization provides the isolation required to lay the foundations of the “vir2us” security architecture. OS virtualization is achieved by inserting a layer (known as the hypervisor) between the OS and the underlying hardware. (Vir2us™ is a trademark of Vir2us, Inc. the applicant of this patent application (formerly known as Self Repairing Computers, Inc.) of San Francisco, Calif.). This layer is responsible for allowing multiple OS instances (and their running applications) to share the resources of a single machine. Multiple alternatives for hypervisors exist on the market today, such as but not limited to Xen, VMware, and others. Each OS thereby believes that it has the resources of the entire machine under its exclusive control, when in fact the virtualization layer transparently ensures that resources are properly shared between different OS images and their applications. However, virtual machines alone still leave a user's data vulnerable to many of the threats posed by malicious code. For example, if a user downloads email in a virtual machine and opens an infected email attachment, the malicious code in that attachment can infect the other email documents accessible from with the virtual machine.

Exemplary Embodiment of the Architecture

The vir2us™ security architecture differences are apparent from the moment the system boots: the desktop Operating System (OS) no longer owns the physical hardware. Immediately following BIOS initialization, the hypervisor is loaded and allowed to run. The hypervisor handles the transition from real-mode to protected-mode and then loads what is referred to by the Xen developers as the DomainO OS (e.g., Linux). The DomainO OS serves only as a control plane for physical device access and Virtual Machine (VM) creation; as soon as its initialization sequence is completed it loads into memory a pre-initialized VM where the proprietary vir2us management services will run, and a separate and isolated pre-initialized Windows™ VM (when a Microsoft Windows VM is desired) to provide the user's desktop.

The Windows™ Virtual Machine (VM) instance providing the user's desktop and the other virtual machines running the user's applications, where individual user files are opened in isolation, are guaranteed to be pristine each time they run because every time they load they run against a newly allocated, and thereby isolated, copy-on-write disk (or other storage device) backed by the initial OS installation or combined or integrated OS+application installation.

Copy-on-Write (sometimes abbreviated to as “COW”) is an optimization strategy whereby a user is allowed to maintain a private copy of a shared system resource, e.g. Logical Unit Number (LUN) or in-memory object, by only allocating blocks on disk (or other storage device or media) or memory when the user makes changes. This may advantageously be applied to a master copy of an operating system (OS), portions of an operating system, application program or programs alone or in combination with an operating system or portion thereof. In one particular non-limiting embodiment, the shared system resource may be a known clean and pristine copy of an operating system (OS), where clean may mean that the copy of the OS is known to be trusted and virus, spyware, hackerware, and otherwise free of malicious code. It may also mean that customizations that may be incompatible with one or more application programs or with an incompatible combination of application programs are not present. The use of a copy-on-write strategy and use of private copies of a shared system resource may advantageously limit the overhead of private copies to the extent of the user's modifications, when the private copies include only modifications. In other embodiments, a complete private copy may be provided at the expense of additional overhead and additional storage. In one non-limiting embodiment the base instance cannot be safely modified once private copies have been made.

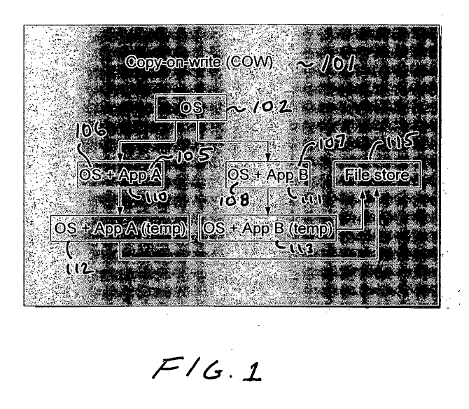

With reference to FIG. 1, in one non-limiting embodiment, a Copy-on-Write COW block device is advantageously used to provide each application (App) or combination of applications to form an application suite with its own private copy of the OS installation. When an application runs (such as when a user clicks on or selects an application from a start menu), it is in turn provided with its own private copy of the application installation. Any resources used will be freed up when the application exits. With reference to the non-limiting embodiment of the copy-on-write method 101 in FIG. 1, a original or master copy of an operating system (OS) 102 may be used to generate a plurality of derivative operating systems with optional changes, customizations, or other modifications. In the example show, the modifications are the installation of an application program A 105 in one of the copied operating systems 106 and the installation of an application program B 107 in the second one of the copied operating systems 108. Each of these two new combination operating system and application program blocks 110, 111 results in an additional temporary copy of the OS+Application installation 112, 113 that has access to the file store 115. Any resources used are advantageously freed up when the application program exits and the temporary copy 112, 113 is deleted.

The system and method describe here creates what may be referred to as an isolated installation. It also provides a system and method for propagating updates to software (operating system, application programs, or other components) through virtual block devices (VBD), (these can also be described as logic volumes).

Consider for example, an existing trusted master template for an installed Microsoft Windows XP Professional operating system that has Service Pack 1 installed. Consider further that several other applications have been installed on top of this operating system such that each has its own private (virtual) disk that may in fact be an isolated portion of a common shared physical disk drive. If during execution or otherwise they add to or modify something, these additions or modifications will not be reflected in the master template. They only have their own private modifications.

In the inventive system, procedures, methods described here, if one installs for example a Microsoft Windows XP OS service pack 2 (or anything else), one does not actually install service pack 2 in the trusted master template, instead one propagates the additions, deletions, changes, updates, and/or upgrades with the individual VBDs that were created from the trusted master version of the operating system, in this instance with its installed service pack 1. It will be appreciated that other methods not described here may be provided to update, upgrade, or otherwise modify the master template or version of the operating system using techniques and protections that maintain the integrity and trusted virus, spy-ware, hacker-ware, and other malicious code free nature of the master template.

As described in further detail herein elsewhere, there may be a physical device and physical block devices corresponding to a physical disk drive, a portion of a physical disk drive, or even a plurality of physical disk drives (or other storage devices). A virtual block device (VBD) is what an individual virtual machine sees and less than the totality of the physical device (such as a slice or portion of the physical device) when some measure of isolation between virtual machines sharing the virtual machine is desired. Relative to a particular virtual machine, that particular virtual machine has the belief or impression that it is seeing the entire physical device.

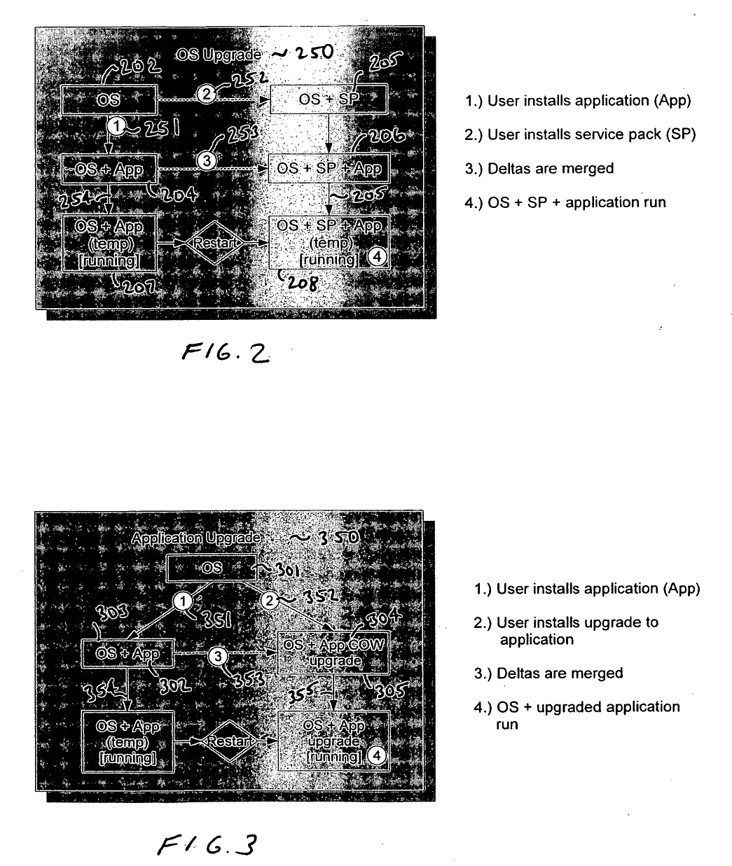

With reference to FIG. 2 and FIG. 3, this copy-on-write and isolation raises the question of how to handle such events as: (i) operating system OS upgrades (See FIG. 2), (ii) application (See FIG. 3) upgrades (such as for example, but not limited to, operating system service packs and patches or other modifications, upgrades, or enhancements), and/or (iii) the sharing of so called helper applications (such as for example but not limited to Acrobat Reader) or other shared features or capabilities between application installs. The solution to this potential issue may involve two components (though the solutions are separable so that either may be used alone or in combination. There are two components to this include (i) the creation of a new COW disk or storage (physical or virtual), and (ii) the propagation of an installation's files from the initial storage to a new storage. Virtual block devices (VBDs) may advantageously be used for the initial COW storage or disk and the new COW storage (COW VBD).

One type of Virtual Block Device is of the type described in the virtual environments where virtual block device or VBD is the term used in discussions for the block device as it is visible to an individual virtual machine or VM instance.

With reference to FIG. 2, there is illustrated an embodiment of a method 250 for making an operating system upgrade. At Step 251 indicated by the circled “1” and starting from the original (e.g., master OS copy or template) 202, an OS+App copy 204 is generated from the original OS 202 when the user installs the application (App). Separately the original OS 202 is updated (Step 252) by having an entity such as the system or the user installing the service pack (SP) to generate an OS+SP 205. Next (Step 253), the OS+App 204 is merged or combined with the updated OS+SP 205 to generate the merged OS+SP+App 206. In embodiments where only user specific changes or deltas are stored, this merging or combination step involves merging or combining of the changes or deltas. Finally (Step 205), a temporary running copy or version of the operating system, service pack update, and application program or programs (OS+SP+App) 208 is executed or run. A temporary running copy or version of the non-updated OS and application program 207 may also optionally be generated (Step 204), and will advantageously be restarted so that the actual executing copy or version will include the SP update.

With reference to FIG. 3, there is illustrated an embodiment of a method 350 for making an application program upgrade. First (step 351), a user or other entity installs an application (or suite or set of applications) 302 to an operating system (OS) 301 to generate a combined OS+App 303. Separately, the user or other entity installs (step 352) an upgrade to an application using the copy-on-write procedure to generate an App COW upgrade 304 and the OS+APP 303 is then merged or combined (step 353) with the APP COW upgrade 304 to generate the merged OS+APP COW upgrade 305. Where only modifications, changes, or deltas are stored or otherwise maintained, the merged versions of the OS+App and OS+App COW upgrade or update are delta version merges. Finally (step 355), a running version or copy of the OS+App COW upgrade is generated. A copy of the OS+App without upgrade or update may be generated as a temporary running copy but (step 354) however it may advantageously result in a restart of the application so that the upgraded version will run in its place.

When VBDs are used for operating system installations (OS installs) either alone or with application program(s), a separate VBD is or may be used for each installation and the system may be described has providing or having a virtual block device per installation.

In a system with a VBD per installation, existing or new application installations may be automatically backed up by copying the VBDs to a shared server since the VBDs store or contain all of the program code, metadata, and other information needed to restore such VBD based backups. Thus when the user finds himself with a new system or computer, restoring application installations involves nothing more than pulling down his/her custom VBDs from the server, from a backup on any media, or stored on any electronically accessible medium.

This exemplary VBD per installation approach provides significant advantages over conventional approaches, systems, and methods. Among the advantages is the ability to perform an isolated installation (as well as an optional corresponding isolated de-installation). The isolated installation may be of the operating system, application programs, or any other files or some combination of these.

In conventional systems and methods, especially on top of a contemporary operating system such as a Microsoft Windows operating system (e.g. Windows 2000, Windows XP, Windows Vista, or the like) the installation of an application program or programs results in the scattering of files and data or meta data throughout the system directory structure as well as modification of existing files such as the updating or directory and registry files or structures. This may usually be problematic and does not support the type of isolation, backup, and transportability provided by the instant invention.

In non-limiting embodiments of the invention that utilize a copy-on-write based VBD, the primary source of the operating system (and optionally the application program or programs) is a trusted master copy (also referred to as a master template since it may be used to generate derivative copies or versions), and the changes or modifications (including for example any additions) are stored in the VBDs. Embodiments that include complete copies or versions with modification or addition may alternatively be utilized but are not preferred because they offer no substantive advantages and consume additional storage space and overhead to create, store, and if ever required to restore.

In embodiments that advantageously utilize change blocks stored in VBDs, the blocks are stored on hard disk drive (or other storage media), and are functionally equivalent to a full VBD. These change VBDs can be copied to a server directly, rather than having to separately keep track of were a given application installation has steered its files, libraries, register changes, or the like to and throughout the file system as in conventional approaches. Non-limiting embodiments of the invention advantageously use the virtual block approach in combination with the copy-on-write cloning of a master template. It will be appreciated that the use of virtual block devices is one implementation approach and that the use of similar or analogous approaches such as the use of logical volumes rather than virtual blocks either with copy-on-write or other cloning approaches. The copy-on-write or other cloning in combination with the existing block device or logical volume as described herein do provide many advantages over conventional systems and methods.

Using this combination, there exists a block device that has an operating system installation. The changes on disk for installing an application are a deterministic and known quantity and one has all the metadata for that change and for the installation. When the modifications pertain to the installation of an application, the set of stored blocks forms or permits the definition of the entirety of the application. This approach therefore permits the simple copying of these blocks and the use of a pointer to the blocks (and the contents of the blocks) so that everything related to the application state is stored on the disk.

In one non-limiting embodiment, the virtual block device may be implemented using a file in a file system and blocks in the file will be allocated as logical changes in the base/reference device are made (logical in that the changes are not actually committed to the base/reference device).

Non-limiting embodiments of the invention create an environment in which the system (and the user) is using or working with a transient VBD except when changing settings or updating. Therefore, when one installs an application program, one is not installing it in the same file system as the master template. Instead, one is creating a copy-on-write based virtual block device relative to the master template. When one then runs an application, on top of or against this virtual block device, any modifications the application program may make are not going to be persistent, unless one intentionally creates it in such a way that they deliberately remain persistent. This is not a problem, because one is able to maintain security and isolation, while still permitting the desired persistent changes in ones own files or data which may then be stored in ones own private virtual (and physical) storage.

The advantage may be better appreciated by considering a real world example. For example, if Microsoft Word is installed and then Word runs a file that has a some embedded macros that run and then corrupt the Windows registry. Even though the registry has been corrupted, when the Word application is exited, the VBD and thus the registry that resides on the file system on the VBD is non-persistent and goes away with the close of the application. The corruption is therefore temporary, transient, and does not impact the next (or even a concurrent different) execution of a Microsoft Word session or in fact any other Windows application program execution that uses or references the registry.

Uninstalling an application in this environment involves nothing more than deallocating the VBD on which its installation resides and deleting any references to it from the desktop.

The automatic partitioning provided by this approach provides an opportunity for increased system availability in the presence of disk drive (or other storage device or subsystem) or other hardware failures. Users in most corporate environments will inevitably customize their systems by installing software particular to their personal wants or needs. This can include anything from the latest Palm™ software to iTunes™. Typically laptop and desktop systems are installed with a pre-defined corporate Information Technology (IT) image. Users then customize their systems further. If the user's hardware fails in some way the user will end up with a fresh image, requiring the user to re-install the software he/she is accustomed to having.

Exemplary Performance and Memory Usage

For the typical usage case, the user's experience will be unchanged. The user will click on (or otherwise interact with) the start menu and select the application that he/she wishes to run. The application will then appear on the desktop. In one non-limiting embodiment of the inventive system (such as for example on a vir2us™ enabled system) the application will not in fact be running in the same operating system (or at least not in the same executing OS even if the application OS and the desktop OS happen to be the same type) as the one providing the desktop. The management or control environment will create a new virtual machine (VM) and then launch the application identified with the start request within it.

Typically, the creation of a new virtual machine is fairly heavyweight, involving either operating system boot-up or the reading in the entirety of an operating system's in-memory image from disk (as may frequently be done when resuming system operation from hibernation). However, in this case, all applications will be running against an equivalently configured operating system. Flash cloning of a desktop operating system instance allows for the creation of a new virtual machine through the allocation of a small amount of extra state in the hypervisor. Cloning is sometimes referred to as forking in the computer, computing, and programming arts, and the term forking is an equivalent or nearly equivalent descriptor. Furthermore, the phrase delta virtualization may sometimes be used as an equivalent or synonym of forking. Flash cloning is applied where the cloning is performed very rapidly. Therefore it may be appreciated that embodiments of the invention include performing the techniques, procedures, and methods described herein whether performed using forking, cloning, delta virtualization, or the like as well as rapidly performed versions of these such as flash cloning, flash forking, flash delta virtualization, or the like.

Unlike the heavyweight operations conventionally required, the inventive use of delta virtualization (or the equivalent flash cloning, forking, or the like) allows creation of a new virtual machine without any initial copying or operating system memory allocation.

The delta virtualization, cloning, forking, or the like operation simply maps all code and data pages from a reference image (for example, from the desktop operating system) into the new virtual machine. The delta virtualization, forked, or clone's mapping may advantageously be write protected so subsequent modifications to pages can then create private copies (this is another instance of the copy-on-write optimization mentioned previously). Using this process, it is possible to utilize an existing process (or the applicable part of it) by only copying the pages in the application that have changed rather than doing everything from scratch. The inventive forking, delta virtualization, and/or flash cloning may therefore be advantageously be used to fork, delta virtualize, or clone a virtual machine in the context of file opening. File opening is further described elsewhere in this application.

It may be appreciated that the term forking is frequently applied in operating system parlance (particularly relative to the Unix OS) relative to an operating system process where one forks a process by making pages of the process to be forked as read only pages. When modification are then made to those pages, the OS allocates a new page, and then copies the page, so that a write operation can be made to the newly allocated page. In a Windows operating system environment, this may correspond to allocation of a new address space rather than allocation of a new page.

Most virtual machine applications appear to emphasize allowing multiple operating systems to share physical hardware. In embodiments of the exemplary vir2us™ system architecture, the virtual machines are intended to provide isolation in a manner that interferes minimally with the user. Thus all applications render to the same display so that they appear to be executing within the same computing environment or machine. Mouse clicks are propagated to the virtual machine running the application under the cursor to in turn pass on to the selected application. Thus, even though each file is opened individually in isolation, the vir2us™ technology is invisible to the user.

Embodiments of system and device architectures that incorporate the vir2us architecture and describe various security features, control and computing environments, and other features are described in co-pending U.S. patent application Ser. No. 10/760,131 filed 24 Jan. 2004 and published as US 20040236874 entitled “Computer System Architecture And Method Providing Operating-System Independent Virus-, Hacker-, And Cyber-Terror-Immune Processing Environments”; Ser. No. 11/386,493 filed 16 Feb. 2006 and published as US 20060161813 entitled “Computer System And Method Having Isolatable Storage For Enhanced Immunity To Viral And Malicious Code Infection”; and Ser. No. 10/484,051 filed 15 Jan. 2004 and published as US 20040210796 entitled “Computer system capable of supporting a plurality of independent computing environments”; each of which is incorporated herein by reference.

There are two other ways one may manage the sharing of physical memory between virtual machines: the use of content-based page sharing and the use of balloon drivers. Content-based page sharing may be implemented by having a process scan memory, storing a checksum of each page as it goes. When the process finds two pages with a matching checksum it does a byte for byte comparison and if they match notifies the hypervisor that the shadow page tables can be updated to both reference the same physical page. The balloon driver runs inside the guest OS itself. It has an interface to allow the hypervisor to request that the driver allocate memory, effectively taking pages away from the guest, and pass the addresses of the memory back to the hypervisor for it to use elsewhere.

Opening a File in the Inventive Architecture

The opening of a file in an exemplary embodiment of the inventive architecture (referred herein as the vir2us architecture) is described relative to a Microsoft Windows implementation; however, it will be appreciated in light of the description provided herein that neither the inventive system, architecture, not method are so limited to Microsoft Windows (any version including the Windows 2000, Windows XP, and the to be released Microsoft Vista™ and Longhorn™ server operating system versions).

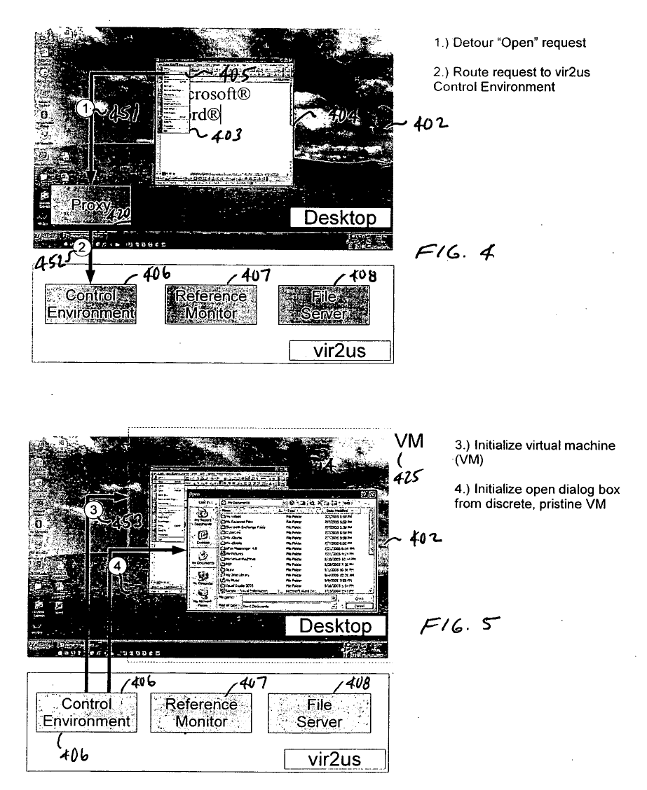

With reference to FIG. 4, there is illustrated an exemplary method 451 for opening a file. FIG. 4 illustrates a user desktop including a Microsoft Windows background screen 402, a pull-down menu 403 within a Microsoft Word application window 404, and a user attempt to open a particular Word file from the file open menu 405. The illustration also shows a control environment block 406, a reference monitor block 407, and a file server block 408. These blocks do not appear on the user desktop screen but are shown to illustrate participation of the blocks and the functions they perform relative to user interactions and the steps involved with at least one embodiment of the inventive method.

During an application's startup its IAT (import address table) is modified by the control environment (such as by a vir2us™ control environment and/or management system) to import an additional DLL for integration (such as for example for vir2us™ integration). This DLL intercepts calls to Windows 32 User Interface (WIN32 UI) functionality, such as the open file and save file dialogs. These calls, such as the open file request call, are detected or identified and “detoured” (Step 451) to a local proxy 420 for the virtual machine 422 (such as for example, a local vir2us™ proxy for the virtual machine). The local proxy 420 in turn routes or forwards (Step 452) the file open request to the control environment of the systems management system (such as for example to a control environment of the vir2us™ management system).

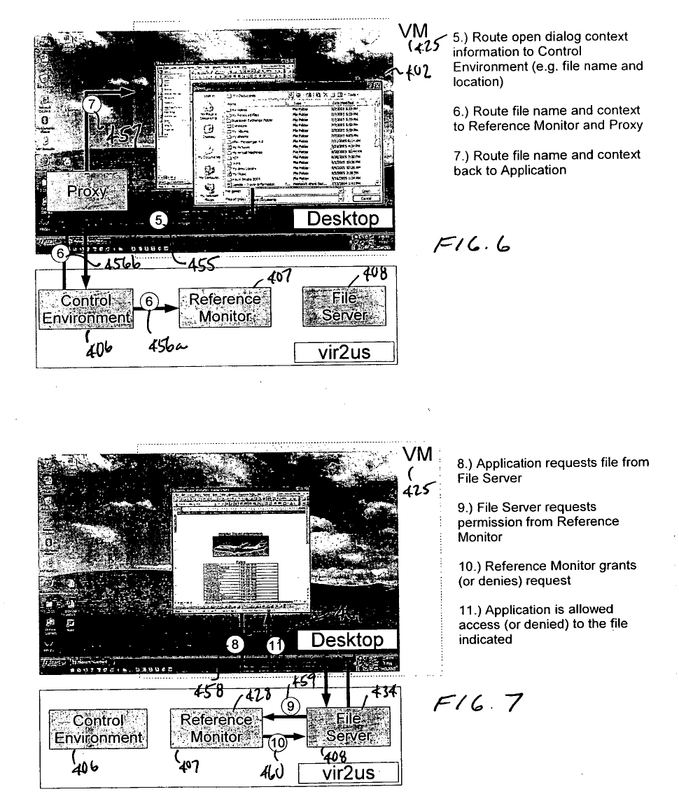

With reference to FIG. 5 and FIG. 6, the management system initializes or creates (step 453) a new virtual machine 425 in which the file open, save, or other file related dialog will run. After the user selects a file name 426 and clicks “OK” or otherwise confirms of finalizes the file selection, the dialog will pass the file name 426 and information back to the originating application 427 and to the management system's reference monitor 428. An open dialog box is then initialized from the discrete pristine virtual machine VM (step 454).

With further reference to FIG. 6, the open dialog context information 430 is routed (step 455) to the control environment of the management system, where in one embodiment the information includes the file name 431 and file location 432. The file name and context 430 is then routed to the reference monitor 428 and proxy 420 (step 456). The file name 431 (and optionally the file location 432) and context are also routed back to the program application (step 457)

With reference to FIG. 7, an application requests (step 458) a file from the file server 434. Because in at least one non-limiting embodiment, all of the virtual machines advantageously run against or using transient private copies of local disk (or other storage), user files are accessed through a file server 434 running in the management or control environment. The file server requests permission from the reference monitor (step 459). All file open requests are therefore advantageously validated by the file server 429 with the reference monitor 428. The reference monitor grants or denies (step 460) request for file access. In the aforementioned example, the reference monitor 428 knows from the file dialog and the pristine state of the virtual machine to permit (or deny) the open request (or other identified file access requests) from the application's virtual machine. The application is therefore allowed access (or denied access) to the file indicated (step 461).

If a file has been previously opened in that virtual machine, the originating application may advantageously be informed that the request was cancelled and the file will be opened in a new instance of that application running in a new VM. If the user chooses to quit the original instance of the application, the exit will be intercepted and the particular virtual machine will exit, freeing up any resources in use. These procedure implement a monitor or reference monitor so that reference monitor validation, verification, or confirmation is required before a predetermined set of file accesses may be performed. Such predetermined file accesses may be selected from one or more of a file open, a file read, a file write, a file save, a file copy, or an other identified file access operations. It may be appreciated that this technique provides significant advantages and features relative to conventional systems and methods.

It may be appreciated that in conventional systems and methods, when a user clicks on or otherwise selects a file, the user gets substantially immediate access to the selected file without any checking, validation, confirmation or the like that it is safe to do so. In such conventional systems and methods, if there is a virus, spy-ware, a Trojan-horse, hacker or other malicious code that is trying to open the file, then that malicious code other will also get immediate and direct access to the file. This is a security risk and problem. In the inventive system and method, the file open command (or other designated file access or other command) is separated so that it opens into its own pristine virtual machine with a trusted operating system.

The availability of the copy-on-write (COW) block device can be used to provide facilities other than just application isolation. In conjunction with the file server 429 the user of a low-end computer or other information appliance can have functionality usually only seen in enterprise storage. This functionality may include, but is not limited to, user schedulable snapshots, permitting the user to look at a file as it was at a previous time (such as a day or week before) and non-disruptive, transparent backup while files are being actively modified. Thus, the user can configure his computer, laptop, or other information appliance so that when he plugs it into his local network the laptop could backup the user's computer files, optionally but advantageously backing up only those parts of the files that have changed rather than the entire changed file or all of the files. This functional capability would save both time and storage space for the backup and restore. Files may be restored in the event that restoration is needed using the backed up changes, perhaps from a plurality of sets of changes that are backed up so that an entire file or set of files may be restored from an appropriate set of changed files. Changed files may of course include an original file at the time it was first created and saved.

It may be appreciated in light of the description provided herein that the invention also provides system and method for transparently extending desktop operating systems that don't scale to large numbers of processors (or processor cores within one or more multi-core processors) by running individual applications in virtual machines using a subset of processors to reduce scalability requirements.

For example, in dual or multi-core processors if there is one instance of an operating system running, there needs to be some clear control or partitioning of tasks among the processors or processing cores. In particular there is a need for file contention locking and unlocking so that current contents of files will be synchronized and consistent between and among the processors or processing cores. There may or will inevitably be some bottleneck as the number of processors or processing cores within a processor or plurality of processors increases. For example, processors or sets of processors having sixty-four of more processors are contemplated. It is easier to run on a single process because there is no locking contention, harder to run on two processors because there is some locking contention, and increasingly more difficult as the number of processors or processor cores increases because of the increased likelihood of file locking contention.

The greater the number of processors, the finer grained the locking control has to be to avoid locking contention. In one non-limiting embodiment of the invention, rather than having one instance of Windows control and schedule tasks and arbitrate file contention between the processors, it is advantageous to provide for each application to execute within its own virtual machine where the virtual machine executes a version of the operating system (such as for example Windows, Apple OS, Linux, Unix, or the like) and that particular virtual machine only sees a limited number of processors or processing cores. The number of processors or processing cores that it sees and has access to may be selected as appropriate to any beneficial level or degree of parallelism.

For example, Microsoft Word or other word processing application programs do not require tremendous processing power so that two cores or even a single core may be sufficient, whereas execution of Adobe Photoshop CS2 may benefit from a multiplicity of processors (depending perhaps on image size, complexity, or selected CS2 processing operation) such as four, five, six, eight or even more (any number) processors or processing cores. All processors or processing cores within a computing machine may still be utilized, but the utilization may be based on the number of different application programs, files to be processed, or upon other factors.

This usage may also permit some processors or processor cores to be operated at a reduced clock speed, voltage, or even turn off entirely to reduce heat and power or energy consumption. In the event that a user or system chooses to provide additional parallelism, the user or the system may make processors of processing cores visible to one, more than one, or all of the virtual machines. For simplicity, embodiments of the invention make all of the virtual machines look like they belong to the same user desktop. It may therefore be appreciated, that one can partition the applications to a subset of processors using similar techniques to those used for virus, hacker code, spy-ware, Trojan horse and/or other malicious code isolation.

It will be appreciated in light of the description provided herein that the inventive procedures, methods, and techniques may advantageously be implemented using computer program code, including executable instructions and optional data. This computer program code may be stored on a computer readable medium so that embodiments of the invention also may include a computer readable medium encoded with a computer program which when executed performs one or a combination of the methods and procedures described herein.

As used herein, the term “embodiment” means an embodiment that serves to illustrate by way of example but not limitation. It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

We claim:

1. A method of operating a computer or information appliance having an underlying hardware and predetermined resources, the method comprising:
providing an operating system for said computer or information appliance;
inserting hypervisor layer between the operating system and the underlying hardware; and
allocating responsibility to said hypervisor for controlling or allowing multiple operating system instances and their running applications to share the resources of a single machine.

2. A computer or information appliance having an underlying hardware and predetermined resources, comprising:
an operating system for said computer or information appliance;
a hypervisor layer inserted between the operating system and the underlying hardware; and
a controller for allocating responsibility to said hypervisor for controlling or allowing multiple operating system instances and their running applications to share the resources of a single machine.

3. A computer program stored on a tangible media for operation on a computer or information appliance and including instructions for operating the computer or information appliance, the instructions including:
an instruction for providing an operating system for said computer or information appliance;
an instruction for inserting hypervisor layer between the operating system and the underlying hardware; and
an instruction for allocating responsibility to said hypervisor for controlling or allowing multiple operating system instances and their running applications to share the resources of a single machine.

4. A method for performing an isolated installation of a computer program code, the method comprising:
creating a copy-on-write based virtual block device;
accessing a trusted master template storing an origin version of the computer program code;
identifying any changes to the origin version required or desired for the computer program code to be installed; and
storing the identified changes to the virtual block device.

5. A method as in claim 4, wherein the computer program code to be installed comprises an operating system computer program code.

6. A method as in claim 4, wherein the computer program code to be installed comprises an application program computer program code.

7. A method as in claim 4, wherein the computer program code to be installed comprises an operating system computer program code and at least one application program code.

8. A method as in claim 4, wherein the changes stored to the virtual block device are less than the entire computer program code needed to execute.

9. A method as in claim 4, wherein the virtual block device is created in a virtual machine environment and refers to a logical portion of a physical storage device.

10. A method as in claim 9, wherein the physical storage device comprises a physical storage device selected from the set of physical storage devices consisting of a physical rotatable hard disk drive, a plurality of rotatable hard disk drives, a solid state memory device, an optical memory device, and combinations of these.

11. A method as in claim 4, wherein the virtual block devices can be copied to a secondary storage and contain all of the changes or pointers to changes required to define the computer program code installation.

12. A method as in claim 4, wherein the isolated installation of the computer program code substantially eliminates steering and distribution of computer program code throughout a computer file system.

13. A method for forking a virtual machine for a file open command, the method characterized in that: a new virtual machine instance is created without any initial copying or operating system memory allocation; and all code and data pages from a reference image are mapped into the new virtual machine.

14. A method as in claim 13, wherein the forking is write protected so subsequent modifications to pages can then create private copies using a copy-on-write procedure.

15. A method as in claim 13, wherein the forking is performed in a virtual machine during a file opening.

16. A method for making an operating system upgrade, the method comprising:
generating an OS+App copy from an original trusted operating system code (OS) when a user attempts to install an application (App);
updating the original OS by installing any desired OS updates to generate an OS+UD;
merging the OS+App with the updated OS+UD to generate a merged OS+UD+App; and
generating a temporary running copy or version of the operating system, operating system update, and application program or programs (OS+UD+App).

17. A method as in claim 16, further comprising executing or running the temporary running copy or version of the operating system, operating system update, and application program or programs (OS+UD+App).

18. A method as in claim 16, wherein the OS update (UD) comprises a service pack update (SP).

19. A method for making an application program code upgrade, the method comprising:
installing an application (App) to an operating system (OS) to generate a combined OS+App;
installing an upgrade to an application using a copy-on-write procedure to generate an App COW upgrade;
merging the OS+App with the APP COW upgrade to generate a merged OS+APP COW upgrade; and
generating a running version or copy of the OS+App COW upgrade.

20. A method as in claim 17, further comprising executing or running the running version of copy of the OS+App COW upgrade.

21. A method as in claim 16, wherein the computer program software code comprises an operating system computer program software code, or an application program software code, or a combination of operating system and application program code.

22. A method for using a reference monitor validation to enforce security in a file access, the method comprising:
detecting a program call or request for a file access;
detouring the detected file access request to a local proxy for a virtual machine;
forwarding the file access request to a management control;
creating a new virtual machine in which a file access dialog will run;
dialog will run;
passing the selected file name back to the originating application and to the management control reference monitor;
initializing a file access dialog box from a trusted pristine virtual machine;
routing file context information to the management control;
routing the file name and file context to the reference monitor and local proxy and back to the program application;
requesting the selected file from a file server running in a management control environment;
requesting, by the file server, permission from the reference monitor to serve the file requested; and
granting or denying the request by the reference monitor.

23. A method as in claim 22, wherein the file access is selected from the set of file accesses consisting of a file open, a file save, a file read, a file write, an any combination of these.

24. A method as in claim 22, wherein the file is served or not served in response to the request depending on the granting or the denying of the request.

25. A method for extending desktop operating systems that don't scale to large numbers of processors, the method characterized in that individual applications are executed in separate virtual machines using only a proper subset of processors or processor cores to reduce scalability requirements.
